(19) United States
(12) Patent Application Publication
(10) Pub. No.: US 2006/0249316 A1
(43) Pub. Date: Nov. 9, 2006

(54) Motorized infantry armor

(76) Inventor: Dennis Buller, (US)

Correspondence Address: DENNIS BULLER, 158 BURN HILL RD, KILLING WORTH, CT, 06419, US

(21) Appl. No.: 11/330,164

(22) Filed: Jan. 12, 2006

Related U.S. Application Data
(60) Provisional application No. 60/643,411, filed on Jan. 13, 2005.

(51) Int. Cl. B62D 11/02; B62D 55/00

(52) U.S. Cl. 180/9.1; 180/6.48

(57) ABSTRACT

With this unique configuration of the driver kneeling and controlling the vehicle with their feet, allows for the driver to use their hands for complicated tasks while still having the use of a powered mobility vehicle.

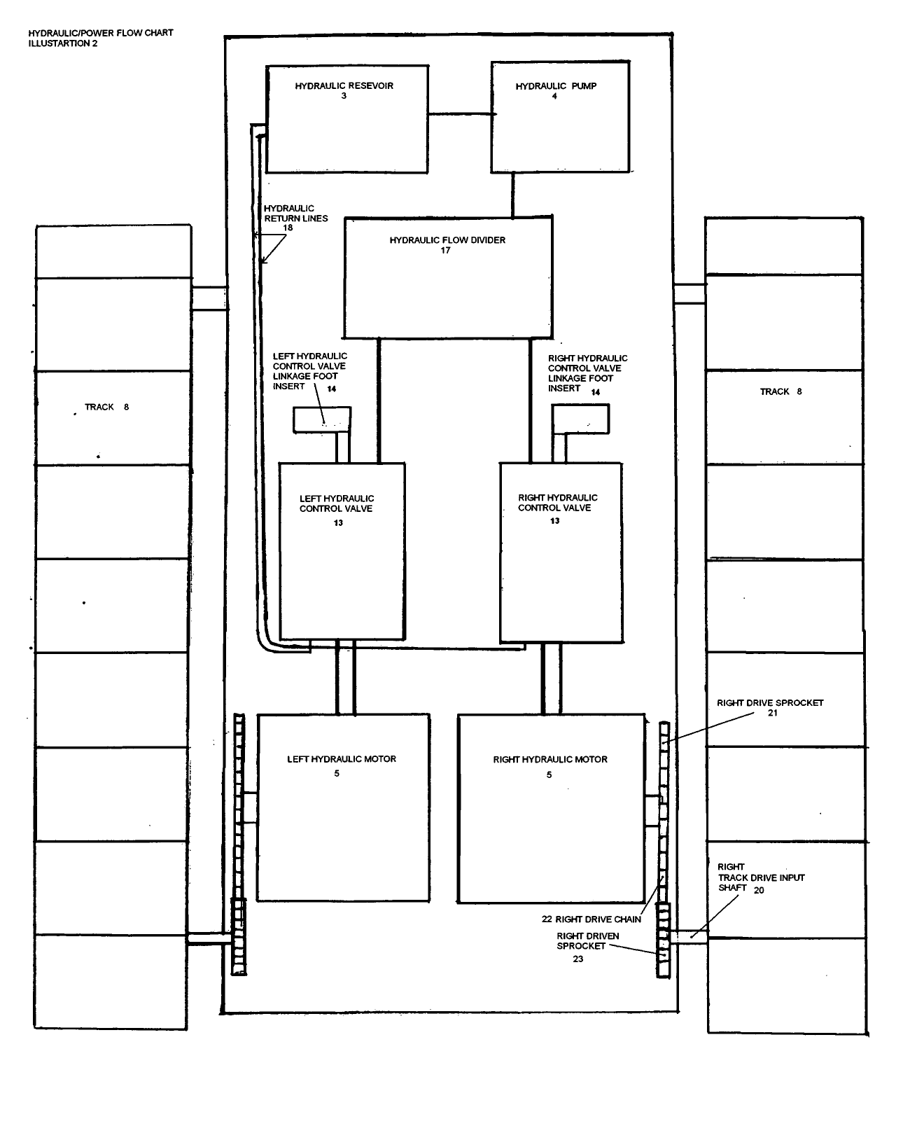

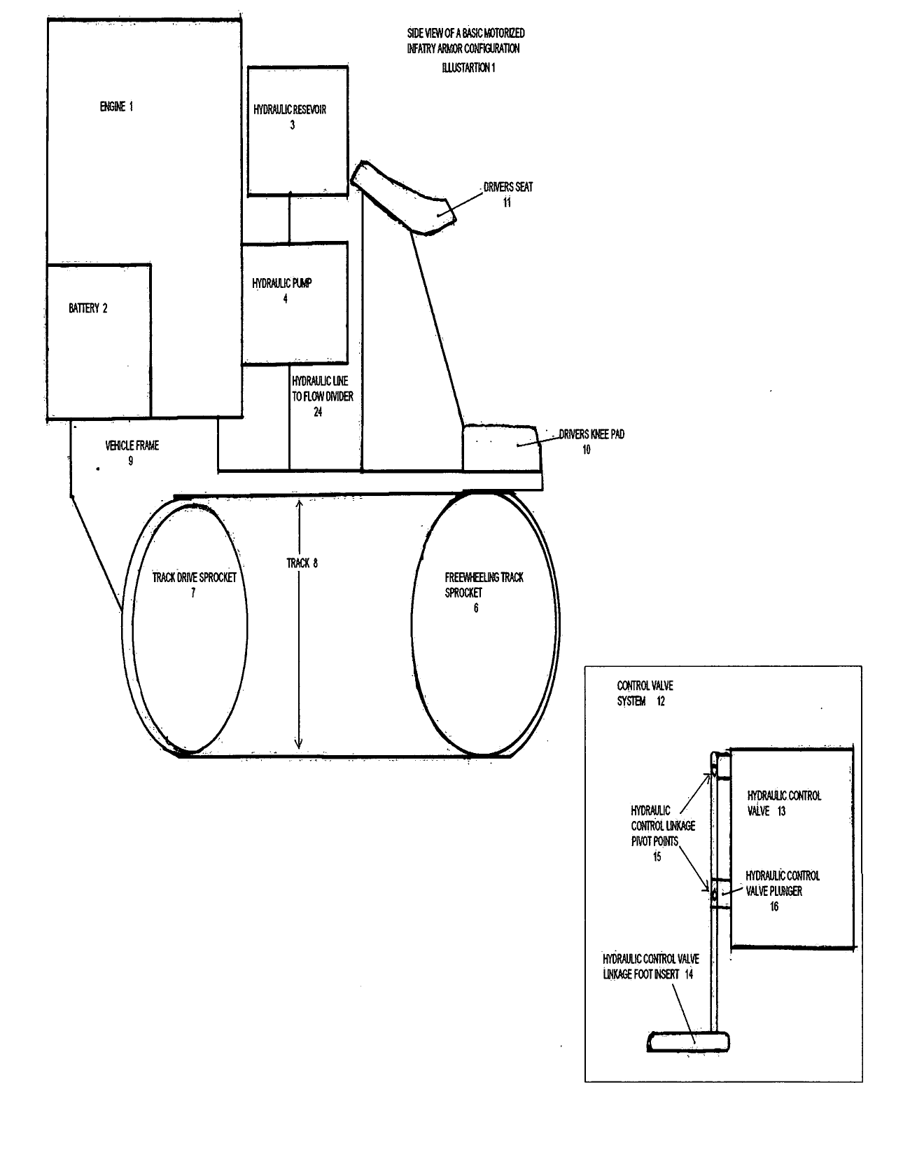

### CROSS-REFERANCE TO RELATED APPLICATIONS

60/643,411

### FEDERALLY SPONSORED RESERCH

None

### SEQUENCE LISTING

None

### BACKGROUND

This invention relates to a powered mobility device. Unlike all previous mobility devises, such as motorcycles, all terrain vehicles, snowmobiles, heavy equipment, skateboards and electric wheelchairs this powered mobility device is designed specifically to allow a forward kneeling position that allows the used complete use of the driver's hands.

This unique configuration is created with the intent of allowing the driver of the vehicle to have complete control of the mobility device while being able to complete complex tasks such as opening doors or handling a weapon.

All previous mobility devises do not allow for both the complete control of the vehicle while allowing for a forward sitting position to allow for the full use of the hands for complicated tasks.

### PRIOR ART

In Yoshio, U.S. Pat. No. 5,947,220 of a snowmobile, the driver may be in a kneeling position, but the directional controls are operated by hand.

In Kunihiko, patent 20050247247 of a personnel watercraft, the driver can kneel but directional control is obtained through the use of the hands.

### OBJECTS AND ADVANTAGES

This concept will allow infantrymen, police officers and security personnel to be mobile, carry much more Kevlar and ceramic armor, protect these people against mines, and allow them to complete complicated tasks such as opening a door or use a weapon while maintaining complete control of the vehicle.

### DRAWINGS

Illustration one shows a basic configuration, which uses an internal combustion engine and a hydraulic system to control and propel a tracked vehicle. Also on this page is a breakdown of the foot control valve, which is unique to the concept.

Illustration two shows a power-tra ydraulic power-flow. It shows how a system would be connected together to achieve the goal of controlling the vehicle with the feet.

### DETAILED DESCRIPTION

Illustration one shows a vehicle, which can be controlled with the driver's feet. The driver kneels on the kneepads (10), rests their buttocks on the seat (11) and inserts their feet into the hydraulic control valve linkage foot insert (14). The driver then move the foot and control the direction of each track individually. Since this version is gas powered, there is an engine (1) and a battery (2) to start it. Since the vehicle has a hydraulic system to convert the power of the engine into useful track movement, there is a hydraulic reservoir (3) and a hydraulic pump (4). The pump sends the pressurized fluid to the hydraulic flow splitter (17). The control valve system is also shown in detail. It is unique to the system since it is allows complete directional control with just the use of the feet. The hydraulic control valve (13) has a plunger, which controls the flow of fluid. It has three positions, neutral, forward and reverse. All of these positions can be obtained buy shifting the Hydraulic control valve linkage foot insert (14) forward and backward. The linkage pivots on two points allowing this to happen (15). Illustration two is a power flow chart. From the hydraulic reservoir (3) the fluid goes to the hydraulic pump (4); which pressurizes it and goes to the hydraulic flow divider (17); then it goes to the control valves (18); where the pressurized fluid is either directed back to the hydraulic reservoir (3) or to the hydraulic motors (20) for either forward or reverse movement. from the hydraulic motors (20) the power is transferred to mechanical motion through a drive sprocket (21); a chain (22); driven sprocket (23); track drive input shaft; to the final destination of the track (8).

### REFERANCE NUMERALS

1. Engine
2. Battery
3. Hydraulic reservoir
4. Hydraulic pump
5. Hydraulic motors
6. Freewheeling track sprocket
7. Track drive sprocket
8. Track
9. Vehicle frame
10. Drivers knee pad
11. Drivers seat
12. Control valve system
13. Hydraulic control valve
14. Hydraulic control valve linkage foot insert
15. Hydraulic control linkage pivot points
16. Hydraulic control valve plunger
17. Hydraulic flow divider
18. Hydraulic return lines
20. Track drive input shaft
21. Drive sprockets
22. Drive chains
23. Driven sprockets
24. Hydraulic line to flow divider

### DETAILED DESCRIPTION

Operation

The engine (1) turns the hydraulic pump (4), which takes hydraulic fluid from the hydraulic reservoir (3) and sends it to the hydraulic flow divider (17) where the pressurized fluid is split into two directions equally. Both hydraulic control valves (13) get an equal amount of fluid no matter what the other is doing. At the hydraulic control valves (13) the position is either set into neutral, forward, or reverse with the movement of the driver's feet. If the neutral position is selected the hy6draulic fluid goes back to the hydraulic reservoir (3); if forward is selected the fluid goes to the hydraulic motor (5) in one direction and if reverse is selected the hydraulic fluid goes to the hydraulic motor (5) in the opposite direction. After going to the hydraulic motor (5) and being used to create rotational movement the fluid then goes back to the hydraulic control valve (13) and is then sent back to the hydraulic reservoir (3).

Once rotational movement is created at the hydraulic motors, this movement is transmitted to the track through a drive sprocket (21), a chain (22), a driven sprocket (23), an input shaft and a track drive sprocket (7).

During all of this operation the driver is in a kneeling position controlling the hydraulic control valves (13) with his feet. He may or may not have his buttocks on a seat. The driver's hands are free to accomplish complicated tasks.

Description

This patent is for a powered vehicle. The one described in this application uses an internal combustion engine (two, four stroke, rotary) and a hydraulic system to accomplish the task of allowing the driver to be in a kneeling position while controlling the vehicle with his feet.

But this vehicle could just as easily be electric, using just batteries, electric motors and electric foot controls.

This vehicle could be a hybrid system using an internal combustion engine to turn a generator, which makes electricity to turn electric motors with the foot controls being electric.

This vehicle could be pneumatic with either an electric motor or internal combustion engine turning a air pump to turn pneumatic motors with the foot controls being air valve; or any other variation of the three.

### CONCLUSION

This patent is creating a new class of vehicle. It is about control, mobility, and being able to complete compicated tasks while maintaining that control and mobility. Any configuration in which the driver is in a kneeling position, while controlling the vehicle with his feet falls under the coverage of this patent.

1. A. An operator in the kneeling position, resting his/her weight on his/her knees and buttocks in a kneeling position

2. B. using motion controls that are activated by the feet

3. C. on a powered mobility vehicle, allows the operator to complete complicated tasks with their hands while maintaining complete control of the vehicle.
